(19) United States
(12) Patent Application Publication
(10) Pub. No.: US 2014/0010529 A1
(43) Pub. Date: Jan. 9, 2014

(54) Method for Detecting and Excluding Failed Optical Network Termination

(71) Applicant: Dong-Soo Shin, Gyeonggi-do (KR)

(72) Inventor: Dong-Soo Shin, Gyeonggi-do (KR)

(73) Assignee: UBIQUOSS Inc., Seoul (KR)

(21) Appl. No.: 13/934,889

(22) Filed: Jul. 3, 2013

(30) Foreign Application Priority Data
Jul. 4, 2012 (KR) 10-2012-0072598

(51) Int. Cl. H04B 10/038

(52) U.S. Cl. CPC H04B 10/038
USPC 398/2

(57) ABSTRACT

Disclosed herein is a method for detecting and excluding a failed optical network termination (ONT) in a passive optical network (PON) system in which an Optical Line Termination (OLT) is connected to a plurality of optical network terminations (ONTs) by an optical passive device. The method for detecting and excluding a failed ONT includes receiving, by the OLT, an optical power level of the ONTs, comparing the received optical power level with a reference value, if the received optical power level does not exceed the reference value, determining that a failed ONT has occurred, and detecting and excluding the failed ONT.

### BACKGROUND OF THE INVENTION

1. Field of the Invention

The present invention relates generally to a failed optical network termination (ONT) and, more particularly, to a method for detecting and excluding a failed ONT, which can detect a failed ONT using a received signal strength indicator (RSSI) detection method and can measure received signal strength indicators (RSSIs) from a plurality of ONTs in optimum order, thereby being able to exclude the failed ONT within minimum time.

2. Description of the Related Art

In general, in a passive optical network (PON) system including a single optical line termination (OLT) and a plurality of optical network terminations (ONTs) or optical network units, the plurality of ONTs transmit respective optical signals, that is, respective pieces of upstream data, to the OLT within their respective assigned times. If at least one of the plurality of ONTs transmits an optical signal to the OLT in a time slot other than its assigned time or in a time slot in excess of its assigned time slot, a collision with another ONT occurs in optical signal transmission, and thus the entire network may enter a state in which communication is impossible.

### SUMMARY OF THE INVENTION

Accordingly, the present invention has been made keeping in mind the above problems occurring in the prior art, and an object of the present invention is to provide a method that detects a failed ONT using RSSI.

Another object of the present invention is to provide a method that detects a failed ONT using RSSI and provides an optimum order in order to overcome a problem with random detection.

Another object of the present invention is to provide a method that rapidly and accurately excludes a failed ONT when the failed ONT occurs.

In order to accomplish the above objects, the present invention provides a method for detecting and excluding a failed ONT, including issuing, by a single OLT, commands to interrupt optical signal transmission for a specific time to a plurality of ONTs in specific order, permanently shutting down a first ONT if the first ONT that has received the command is determined to be a failed ONT, continuously issuing commands to interrupt optical signal transmission for the specific time in the order if the first ONT that has received the command is determined to be a normal ONT, and permanently shutting down a second ONT if the second ONT that has received the command is determined to be a failed ONT.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram illustrating the configuration of a GPON system according to an embodiment of the present invention;

FIG. 2A is a configuration diagram illustrating normal data upstream transmission in connection with the present invention;

FIG. 2B is a configuration diagram illustrating abnormal data upstream transmission in connection with the present invention;

FIG. 3 is a flowchart method illustrating a method of determining whether a failure has occurred in an ONT using RSSI according to the present invention;

FIG. 4 is a flowchart illustrating a process of determining RSSIs with respect to ONTs in an order in which the ONTs were recently registered with an OLT according to the present invention; and

FIG. 5 is a flowchart illustrating a process of determining RSSIs in alphabetical or numeral order of ID unique numbers assigned to ONTs according to the present invention.

### DESCRIPTION OF THE PREFERRED EMBODIMENTS

Embodiments of the present invention will be described in detail below with reference to the accompanying drawings. However, the embodiments of the present invention may be modified in various manners, and the scope of the present invention is not limited to the embodiments that will be described below. The embodiments of the present invention are provided merely to describe the present invention to those of ordinary skill in the technical field to which the present invention pertains. Furthermore, in the following description of the present invention, terms will be defined in the context of functions in the present invention. Since the meanings of the terms may vary depending on the intentions of those of ordinary skill or customary usage in the technical field, they should not be construed as limiting the technical elements of the present invention.

A GPON system according to an embodiment of the present invention will be described in detail below with reference to the accompanying drawings.

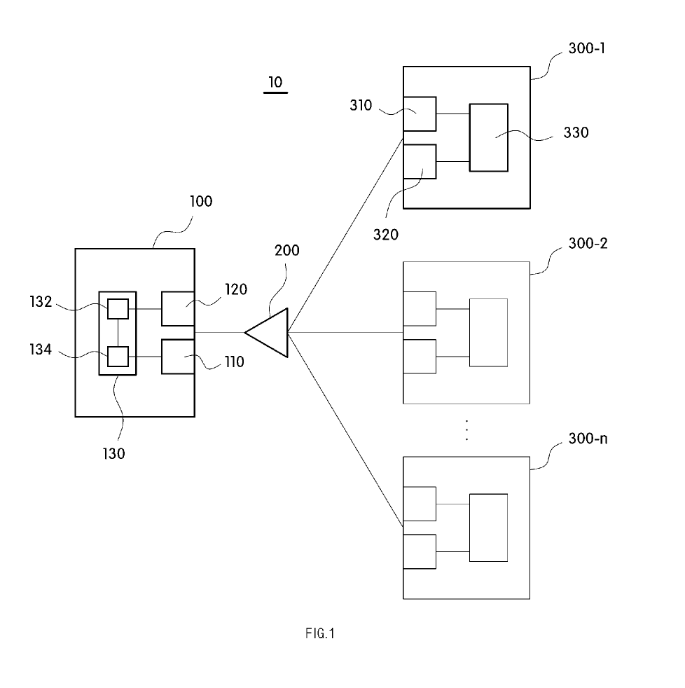

FIG. 1 is a configuration diagram illustrating the configuration of a GPON system according to an embodiment of the present invention.

As illustrated in FIG. 1, the PON system 10 of the present invention corresponds to one of optical subscriber construction methods for providing optical fiber-based high-speed service up to a corporation or a typical home, and is related to a method that is capable of connecting a plurality of ONTs 300-1 to 300-n to a single OLT 100 using a splitter 200, that is, an optical passive device.

The PON system 10 may be classified as a time division multiplexing (TDM)-PON using a TDM method, or as a wavelength division multiplexing (WDM)-PON using a WDM method. The PON system 10 using a TDM method includes an asynchronous transfer mode (ATM)-PON using an ATM method, an E-PON based on an Ethernet, and a G-PON using a general frame protocol.

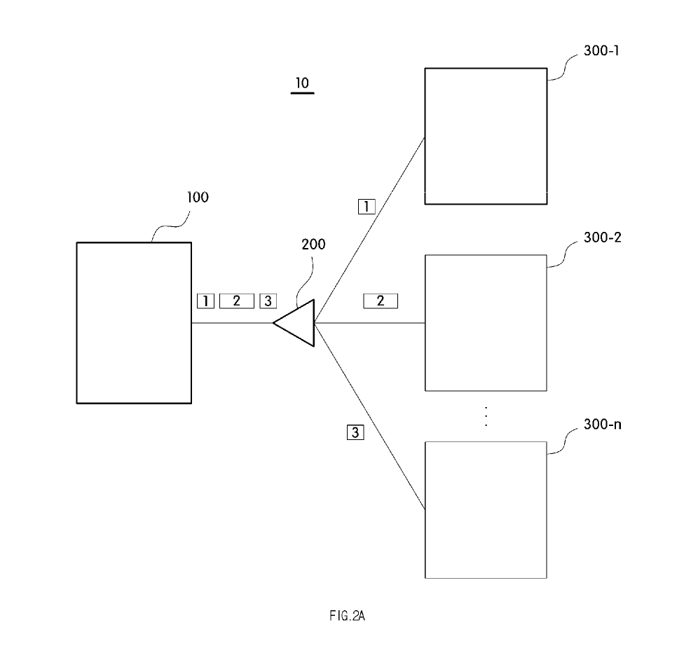

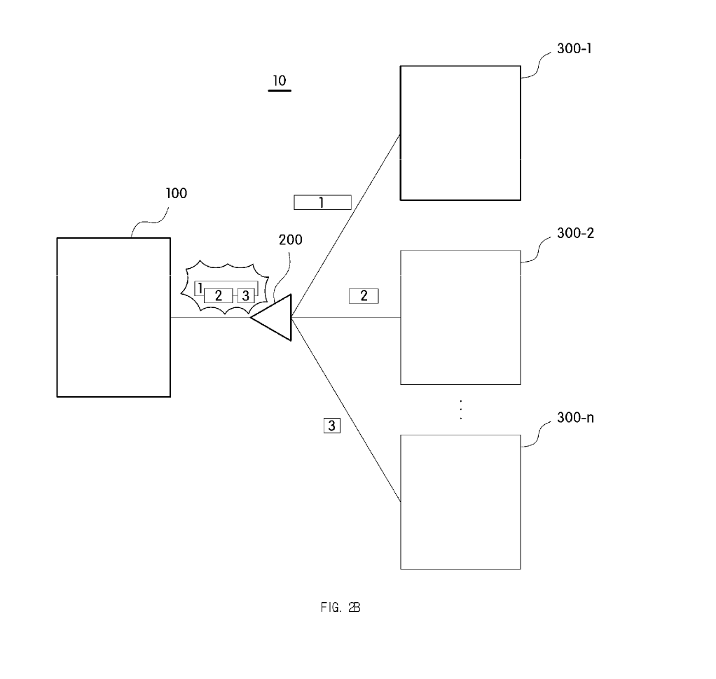

The operation of the PON system 10 using a TDM method is as follows. In the case of downstream transmission in which data is transferred from the OLT 100 to the ONTs 300-1 to 300-n, the OLT 100 transmits data with the registered IDs of the ONTs 300-1 to 300-n inserted into the preambles of respective frames, and each of the ONTs 300-1 to 300-n receives only a frame having its ID. However, as illustrated in FIG. 2A, in the case of upstream transmission in which data is transferred from the ONTs 300-1 to 300-n to the OLT 100, the OLT 100 assigns upstream time slots to the respective ONTs 300-1 to 300-n, and each of the ONTs 300-1 to 300-n can transmit data to the OLT 100 only within its assigned time slot.

In the above-described upstream transmission, when a failure occurs in an ONT 100-1 and thus a laser diode continuously emits light, as illustrated in FIG. 2B, the failed ONT 300-1 dominates the overall time slot of the upstream transmission, and thus problems arise in that another ONT 300-2 is prevented from transmitting data to the OLT 100 and the OLT 100 determines that another ONT 300-2, . . . , or 300-n in which a failure has not occurred has not made an accurate response.

Accordingly, the present invention is configured to quickly detect the continuous light emission of a laser diode attributable to the occurrence of the failure in an ONT 300 and to shut down the optical module of the failed ONT 300, thereby enabling the operation of the PON system 10 to be smoothly performed.

Referring back to FIG. 1, each of the ONTs 300-1 to 300-n may include an optical transmission module 310, an optical reception module 320, and a control unit 330.

The optical transmission module 310 transmits an optical signal to the OLT 100 in compliance with a command of the control unit 330. The optical transmission module 310 may include a laser diode configured to output an optical signal and a laser drive unit configured to operate a laser diode.

The optical transmission module reception module 320 receives an optical signal from the OLT 100. The optical reception module 320, as well as the optical transmission module 310, may be implemented as a single module.

The control unit 330 functions to shut down the optical transmission module 310 when an optical signal transmission interruption command is issued by the OLT 100.

The OLT 100 may include an optical transmission module 110, an optical reception module 120, and a control unit 130.

The optical reception module 120 receives optical signals from the plurality of ONUS 300. The optical reception module 120 may include a photo diode configured to receive an optical signal and to convert the optical signal into an electrical signal and an amplifier configured to amplify the resulting electrical signal.

The control unit 130 provides transmission data and an optical active signal to the optical transmission module 110, receives data into which an optical signal received by the optical reception module 120 has been photo-electrically converted from the optical reception module 120 and processes the data, and controls the general operation of the OLT 100.

The control unit 130 may further include a received signal strength indicator (RSSI) detection unit 132 and a failure determination unit 134.

The RSSI detection unit 132 detects the received signal strength of a received optical signal. The failure determination unit 134 determines whether a failure has occurred in the ONT 300-1. The failure determination unit 134 compares an optical power level detected by the RSSI detection unit 132 with a reference value, and determines a state in question to be a normal state if the optical power level does not exceed the reference value, and determines the state in question to be a failure state if the optical power level exceeds the reference value.

In this case, the optical power level is the sum of optical signal strengths of the ONTs 300-1, . . . , and/or 300-n that share the same optical line with the OLT 100. When the ONT 300-1 fails, the optical power level is equal to the sum of the optical signal strength of the failed ONT 300-1 and the optical signal strength of the normal ONT 300-2. The reference value is an optical power level that is established when the optical transmission module 310 of the single normal ONT 300-2 emits light.

That is, when the ONT 300-1 does not fail, the received optical power level is kept the same as the reference value in a normal state. In contrast, if the ONT 300-1 fails, the received optical power level must exceed the reference value because of the continuous light emission of the failed ONT 300-1.

That is, since one of 32 ONTs emits light in a normal state, the received optical power level may be maintained at the uniform reference value on an average basis. However, when the failed ONT 300-1 emits light and simultaneously the normal ONT 300-2 emits light, the received optical power level must exceed the reference value.

The failure determination unit 134 may be provided inside the control unit 130 or independently of the control unit 130. The control unit 130 transmits a failure message to the ONT 300-1 via the optical transmission module 110 when the failure determination unit 134 detects a failure.

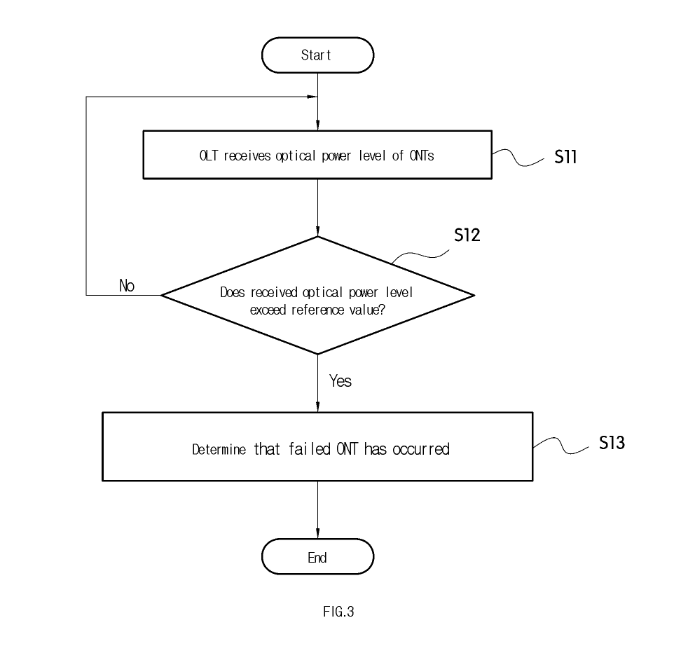

FIG. 3 is a flowchart method illustrating a method of determining whether a failure has occurred in an ONT using RSSI according to the present invention.

Referring to FIG. 3, the OLT 100 receives the optical power level of the ONTs 300 at step S11, whether the received optical power level exceeds the reference value is determined at step S12, and, if the received optical power level exceeds the reference value, it is determined that a failure has occurred in the ONT 300-1 and then measures are taken at step S13.

Since the normal ONT 300-2 transmits an optical signal in its assigned time slot in accordance with a TDM method, the OLT 100 may identify the ONT 300-2 from which a received optical signal originated. In contrast, since the failed ONT 300-1 tends to continuously emit light regardless of its assigned time slot, the OLT 100 cannot identify the failed ONT 300-1. In particular, at least 32 ONTs 300-1 to 300-32 are usually connected to a single OLT 100, it is not economical in terms of time to randomly check the 32 ONTs 300-1 to 300-32 for a failure.

Accordingly, according to another embodiment of the present invention, a failed ONT is detected and excluded using the following process.

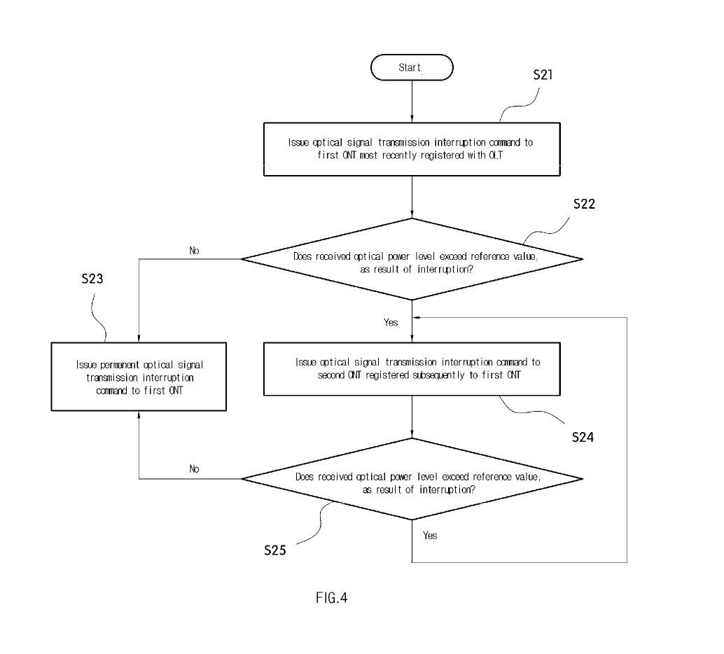

FIG. 4 is a flowchart illustrating a process of determining RSSIs with respect to ONTs in an order in which the ONTs were recently registered with an OLT according to the present invention.

Referring to FIG. 4, when the failed ONT 300-1 is detected, the OLT 100 issues commands to interrupt optical signal transmission for a predetermined time to the ONTs 300 in order starting from an ONT 300 that was most recently registered with the OLT 100. Such optical signal transmission interruption messages may be sequentially delivered from the OLT 100 to the ONTs 300 via OAM frames.

For example, an optical signal transmission interruption command is issued to an ONT 300 that was most recently registered with the OLT 100 at step S21. It is determined whether the received optical power level returns to the reference value as a result of the interruption of the operation of the optical transmission module 310 of the corresponding ONT 300 at step S22. If the received optical power level returns to the reference value as a result of the interruption and the received power level exceeds the reference value as a result of the release of the interruption, it is determined that the corresponding ONT 300 is performing abnormal light emission. To exclude the failed ONT 300, a command to permanently interrupt optical signal transmission is issued to the corresponding ONT 300 at step S23.

If the received optical power level does not return to and continuously exceeds the reference value regardless of the interruption, it is determined that the corresponding ONT 300 is operating normally.

Thereafter, an optical signal transmission interruption command is issued to an ONT 300 that was subsequently registered at step S24. It is determined whether the received optical power level of the corresponding ONT 300 returns to the reference value as a result of the interruption at step S25. If the received optical power level returns to the reference value as a result of the interruption and the received power level exceeds the reference value as a result of the release of the interruption, it is determined that the corresponding ONT 300 is performing abnormal light emission. Then a command to permanently interrupt optical signal transmission is issued to the corresponding ONT 300. As a result, the corresponding ONT 300 is shut down, and is completely excluded from the topology.

Otherwise the above-described process is repeatedly performed. By forcibly blocking power supply to the failed ONT 300-1 as described above, the optical transmission module 310 of the failed ONT 300-1 can be fundamentally prevented from continuously outputting optical signals and thus causing a communication failure with regard to the remaining normal ONTs 300 that are sharing the same optical line.

A process of determining a failed ONT according to still another embodiment of the present invention is as follows.

In this embodiment, the OLT 100 is responsible for the processing of the registration and authentication of an ONT 300 using a GPON transmission convergence (GTC) frame before permitting the upstream traffic transmission of the ONT 300. For example, the OLT 100 requests serial numbers from respective ONTs 300 in a broadcast manner, and receives Physical Layer Operations, Administration and Maintenance (PLOAM) messages including the serial numbers from the respective ONTs 300. The OLT 100 assigns IDs to the respective ONTs 300 in light of the serial numbers, thereby completing a registration procedure.

When the failed ONT 300 is detected, commands to interrupt optical signal transmission for a predetermined time are issued in order of the unique numbers of the IDs assigned to the ONTs 300 while consulting the serial numbers, and then it is determined by comparing a resulting received optical power level with the reference value whether the corresponding ONT 300 is performing abnormal light emission.

The serial numbers may be composed of alphabetical letters. Accordingly, the order thereof may be alphabetical order. In some cases, the serial numbers may be composed of Arabic numerals, and the order thereof may ascend from the smallest number to the largest number. Alternatively, the serial numbers may be composed of combinations of alphabetical letters and Arabic numerals.

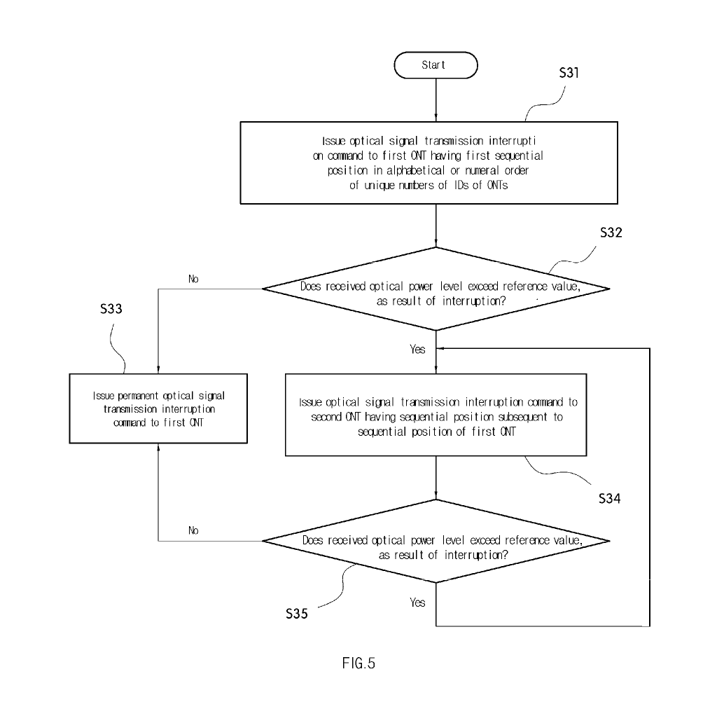

FIG. 5 is a flowchart illustrating a process of determining RSSIs in alphabetical or numeral order of ID unique numbers assigned to ONTs according to the present invention.

Referring to FIG. 5, a command to interrupt optical signal transmission is issued to an ONT 300 having a first unique number in alphabetic or numeral order of the unique numbers of the IDs of the ONTs 300 at step S31. It is determined whether the received optical power level exceeds the reference value as a result of the interruption of the optical signal transmission at step S32. If the received optical power level does not exceed the reference value, a command to permanently interrupt optical signal transmission is issued to the corresponding ONT 300 at step S33. In contrast, if the received optical power level does not exceed the reference value, a command to interrupt optical signal transmission is issued to a subsequent ONT 300 at step S34. In this case, if it is determined at step S35 that the received optical power level does not exceed the reference value, a command to permanently interrupt optical signal transmission is issued to the corresponding ONT 300 at step S33. Otherwise the above-described process is repeatedly performed.

From the foregoing description, it can be seen that the present invention is configured to detect a failed ONT using RSSI functionality and also to rapidly detect and exclude the failed ONT in order of being registered with the OLT or in alphabetical order of the serial numbers of the IDs of ONTs because it may take a considerably long time to detect the failed ONT in a random manner.

As described above, according to the above-described configuration of the present invention, the following advantages may be expected.

First, according to the present invention, the PON system is configured to compare an optical power level output to the OLT with a reference value and to determine whether the output of the optical signal is normal or abnormal, thereby accurately detecting an ONU that abnormally emits light regardless of its assigned time slot from among a plurality of ONUs that output optical signals to the OLT in the PON system.

Second, the present invention is configured to control the operation of a failed ONU using RSSI, and to detect the failed ONT from among 32 or 64 ONTs that share a single optical line within a short period of time by taking into account the fact that the possibility of abnormal light emission occurring in an ONT recently registered with the OLT is strong.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Method for detecting and excluding a failed optical network termination (ONT), comprising:
issuing, by a single optical line termination (OLT), commands to interrupt optical signal transmission for a specific time to a plurality of optical network terminations (ONTs) in a specific order;
if a first ONT that has received the command is determined to be a failed ONT, permanently shutting down the first ONT;
if the first ONT that has received the command is determined to be a normal ONT, issuing commands to interrupt optical signal transmission for a specific time to the plurality of ONTs in the order; and
if a second ONT that has received the command is determined to be a failed ONT, permanently shutting down the second ONT.

2. The method of claim 1, wherein the first ONT is an ONT that was most recently registered with the OLT.

3. The method of claim 1, wherein the first ONT is first in alphabetical or numeral order of IDs that were assigned to the ONTs in light of serial numbers when the OLT registered and authenticated the OLTs.

4. The method of claim 1, wherein the determination that the first ONT that has received the command is the failed ONT is a determination that when the first ONT that has received the command emits light regardless of its assigned time slot and is then interrupted temporarily, the optical power level received by the OLT returns to a reference value.

5. In a passive optical network (PON) system in which an OLT is connected to a plurality of ONTs by an optical passive device, a method for detecting and excluding a failed ONT, comprising:
receiving, by the OLT, an optical power level of the ONTs;
comparing the received optical power level with a reference value;
if the received optical power level does not exceed the reference value, determining that a failed ONT has occurred; and
detecting and excluding the failed ONT.

6. The method of claim 5, wherein the failed ONT continuously emits light regardless of its time slot that is assigned by the OLT.

7. The method of claim 5, wherein the optical power level is a sum of optical signal strengths of the ONTs that share an identical optical line with the OLT.

8. The method of claim 5, wherein the reference value is an optical power level that is generated when an optical transmission module of a normal single ONT emits light.

9. The method of claim 5, wherein excluding the failed ONT comprises:
transmitting a message indicative of temporary interruption of optical signal transmission to a first ONT that was most recently registered with the OLT; and
if, as a result of the interruption of the optical signal transmission, the received optical power level does not exceed the reference value, transmitting a message indicative of permanent interruption of optical signal transmission to the first ONT.

10. The method of claim 9, further comprising:
if, as a result of the interruption of the optical signal transmission, the received optical power level exceeds the reference value, transmitting a message indicative of temporary interruption of optical signal transmission to a second ONT that was registered with the OLT subsequently to the first ONT; and
if, as a result of the latter interruption of the optical signal transmission, the received optical power level does not exceed the reference value, transmitting a message indicative of permanent interruption of optical signal transmission to the second ONT.

11. The method of claim 5, wherein excluding the failed ONT comprises:
transmitting a message indicative of temporary interruption of optical signal transmission to a first ONT that has a first sequential position of sequential positions of serial numbers that are taken into account when the OLT assigns IDs to the ONTs upon registration and authentication; and
if, as a result of the interruption of the optical signal transmission, the received optical power level does not exceed the reference value, transmitting a message indicative of permanent interruption of optical signal transmission to the first ONT.

12. The method of claim 11, further comprising:
if, as a result of the interruption of the optical signal transmission, the received optical power level exceeds the reference value, transmitting a message indicative of temporary interruption of optical signal transmission to a second ONT that has a sequential position subsequent to the sequential position of the first ONT; and
if, as a result of the latter interruption of the optical signal transmission, the received optical power level does not exceed the reference value, transmitting a message indicative of permanent interruption of optical signal transmission to the second ONT.

13. The method of claim 11, wherein the serial numbers are composed of alphabetic letters, and the order is alphabetical order.

14. The method of claim 11, wherein the serial numbers are composed of Arabic numerals, and the order is ascending order of the serial numbers.
